(19) United States
(12) Patent Application Publication
(10) Pub. No.: US 2026/0179965 A1
(43) Pub. Date: Jun. 25, 2026

(54) RELEASE LAYER FOR ALKALI METAL ON PLASTIC SUBSTRATES

(71) Applicant: Applied Materials, Inc., Santa Clara, CA (US)

(72) Inventor: Subramanya P Herle, Santa Clara, CA (US)

(21) Appl. No.: 19/124,320

(22) PCT Filed: Oct. 10, 2023
(86) PCT No.: PCT/US2023/034785

§ 371 Date: Apr. 25, 2025

Related U.S. Application Data
(60) Provisional application No. 63/420,322, filed on Oct. 28, 2022.

(51) Int. Cl. H01M 4/66; H01M 10/052; H01M 50/451

(52) U.S. Cl. CPC H01M 4/661; H01M 10/052; H01M 50/451

(57) ABSTRACT

An alkali metal-containing film stack for energy storage devices is provided. The alkali metal-containing film stack can be a lithium film stack having a flexible support layer and a release layer disposed over the flexible support layer capable of separating from the flexible support layer. The release layer includes one or more nanosheets, such as two-dimensional materials. An alkali metal-containing layer, such as a lithium layer is disposed over the release layer.

### BACKGROUND

### Field

Embodiments of the present disclosure generally relate to electrode coatings and methods of coating electrodes.

### Description of the Related Art

Lithium (Li) ion batteries have played a vital role in the development of current generation mobile devices, microelectronics, and electric vehicles. A typical Li-ion battery is made of a positive electrode (cathode), a negative electrode (anode), an electrolyte to conduct ions, a porous separator membrane (electrical insulator) between the two electrodes to keep the electrodes physically apart, and the packaging.

Typically, lithium batteries can include a graphitic material as the anode. Use of graphite can have a lower capacity in comparison with the use of silicon-blended graphite. Currently, the industry is moving away from graphitic-based anodes to silicon-blended graphite to increase energy cell density. Silicon blended graphite anodes can show first cycle irreversible capacity loss (IRC). Li-ion battery specific energy and energy density appreciably decline due to active lithium loss during the first cycle charge when approximately five to twenty percent of the lithium from the cathode is consumed by solid electrolyte interphase formation (“SEI”) at the anode.

Anode pre-lithiation prior to the first cycle charge is a common strategy for compensating active lithium loss. Furthermore, pre-lithiation provides other performance and reliability advantages to Li-ion battery performance. For example, pre-lithiation can decrease Li-ion battery impedance thereby improving rate capability. In addition, for silicon-based anodes, pre-lithiation can mitigate silicon cracking and pulverization by pre-expanding the silicon to enhance anode mechanical stability.

During pre-lithiation, current processes can result in lithium being released into the environment. Therefore, there is a need for processes and protective layers added to a surface of the lithium that is stable against lithium at high temperatures, and prevents exposure of lithium into the environment.

### SUMMARY

In one aspect, an alkali metal-containing film stack for energy storage devices is provided. The alkali metal-containing film stack includes a flexible support layer. A release layer is disposed over the flexible support layer and is capable of separating from the flexible support layer. The release layer includes one or more nanosheets. An alkali metal-containing layer is disposed over the release layer.

Embodiments may include one or more of the following. The film stack further comprises an electrolyte-containing layer disposed between the release layer and the alkali metal-containing layer. The alkali metal-containing layer comprises lithium. The film stack comprises one or more additional film layers disposed between the flexible support layer and the alkali metal-containing layer, each of the one or more additional film layers having a melting point higher than a melting point of the alkali metal-containing layer. The flexible support layer comprises a material selected from the group consisting of polyethylene terephthalate (PET), paper, and a combination thereof. The one or more nanosheets comprises a two-dimensional material is selected from the group consisting of titanium disulfide (TiS₂), tungsten disulfide (WS₂), molybdenum disulfide (MoS₂), boron nitride (BN), aluminum hydroxide oxide (AlHO₂), MoO₃, graphene, carbon fluoride (CFx), carbon nitride, layered double hydroxide, derivatives thereof, and combinations thereof. The alkali metal-containing layer is capable of adhering to an anode. The release layer has a thickness of about 1 nm to about 500 nm. An energy storage device comprising an anode and the film stack disposed over the anode.

In another aspect, a method of making a storage device is provided. The method includes disposing a release layer over a flexible support layer. The release layer includes one or more nanosheets. The method includes evaporating an alkali metal onto the release layer and transferring the release layer and the alkali metal to a substrate to form the energy storage device.

Embodiments may include one or more of the following. The one or more nanosheets comprise a two-dimensional material, wherein the two-dimensional material is transferred to the flexible support layer by coating a roller with a powder comprising the two-dimensional material and pressing the roller against the flexible support layer to transfer the powder from the roller to the flexible support layer while the flexible support layer is conveyed on a surface of one or more rollers. The one or more nanosheets comprise a two-dimensional material, wherein the two-dimensional material is transferred to the flexible support layer by pressing a solid comprising the two-dimensional material against the flexible support layer as the flexible layer is conveyed on a surface of one or more rollers. Pressing the solid comprises applying spring tension against the solid in a direction perpendicular to the surface of the flexible support layer. The one or more nanosheets are deposited by chemical vapor deposition, atomic layer deposition, molecular layer deposition, physical vapor deposition, or combinations thereof. The method further comprises depositing an electrolyte containing layer over the release layer. The plastic substrate could be activated using corona or plasma surface treatment for good adhesion of 2D material.

In yet another aspect, a method of making an energy storage device is provided. The method includes disposing a release layer over a flexible support layer. The release layer includes a two-dimensional material. The method includes evaporating lithium onto the release layer to form a lithium layer. The method includes transferring the release layer and the lithium layer to a substrate to form the energy storage device.

Embodiments may include one or more of the following. The release layer and the lithium layer are deposited in the same process chamber. The release layer is transferred onto the flexible support layer in a first chamber and the lithium layer is deposited onto the release layer in a second chamber. The method further comprises depositing an electrolyte-containing layer over the release layer, wherein the electrolyte-containing layer is deposited in the first chamber or the second chamber. The release layer is transferred onto the flexible support layer in a first chamber and the lithium layer is deposited onto the release layer in the first chamber.

In another aspect, a non-transitory computer readable medium has stored thereon instructions, which, when executed by a processor, causes the process to perform operations of the above apparatus and/or method.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a schematic cross-sectional view of a lithium-containing film stack, according to some embodiments described herein.

FIG. 2 illustrates a schematic cross-sectional view of a lithium-containing film stack with solid electrolyte layer, according to some embodiments described herein.

FIG. 3 illustrates a schematic cross-sectional view of a vapor deposition system, according to some embodiments described herein.

FIG. 4 illustrates a schematic cross-sectional view of a vapor deposition system, according to some embodiments described herein.

FIG. 5 illustrates a schematic cross-sectional view of a two-dimensional material deposition apparatus, according to some embodiments described herein.

FIG. 6 illustrates a schematic cross-sectional view of a two-dimensional material deposition apparatus, according to some embodiments described herein.

FIG. 7 illustrates a system for transferring one or more layer of a film stack to a substrate, according to some embodiments described herein.

FIG. 8 illustrates a block flow diagram of a process for forming energy storage devices, according to some embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Energy storage devices, for example, Li-ion batteries, typically include a positive electrode (e.g., cathode) and a negative electrode (e.g., anode) separated by a plurality of layers. Solid-state batteries also typically include a positive electrode and a negative electrode with an ion-conducting material disposed therebetween. A Solid Electrolyte Interface (SEI) layer is typically formed in-situ during the formation cycle on the anode and cathode material surfaces. The SEI aids long-cycling performance of the cell.

Substrate independent direct transfer (SIDT) is a method to form lithium metal anodes and pre-lithiate anodes in energy storage devices in order to improve the life cycles of the batteries. These anodes can include, but are not limited to, graphite, silicon, silicon graphite, silicon oxide graphite, silicon, metalized plastic, and copper. In SIDT processes, lithium is first deposited on a support layer composed of one or more materials such as polyethylene terephthalate (PET), paper, or combinations thereof. The materials on the support layer are directly transferred to the anode for pre-lithiation or to a current collector to form a lithium metal anode on the current collector. A release layer enables transferring lithium and other materials off of the support layer and onto the anode.

Conventional release layers remain on the support layer after transferring the lithium and other layers. This decreases the ability for the support layers to be reused in subsequent SIDT processes. This also causes the lithium transferred onto the anode to be exposed, which can affect device stability, especially at higher temperatures. The device and methods described herein enable transferring the release layer along with the lithium layer to the anode in which the release layer acts as a protective layer over the lithium upon transfer.

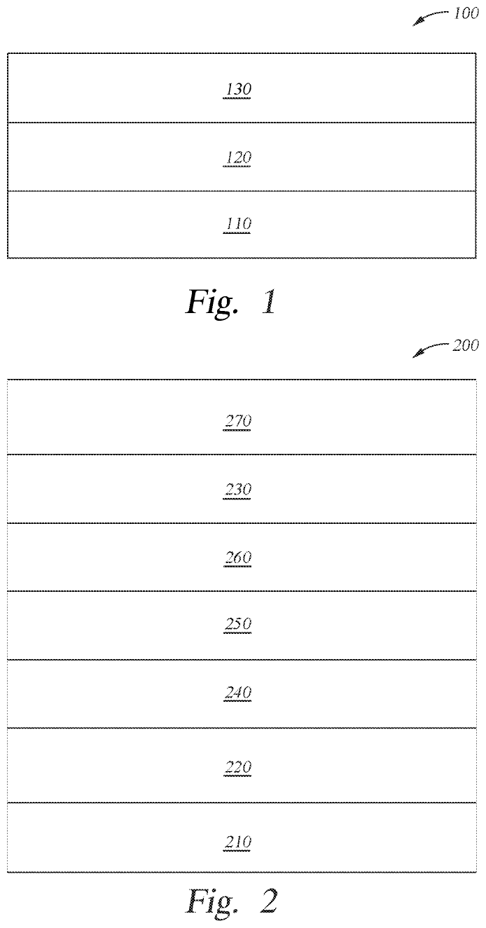

FIG. 1 illustrates a schematic cross-sectional view of one embodiment of a SIDT film stack 100. The SIDT film stack 100 includes a support layer 110, a release layer 120, and an alkali metal-containing layer 130, such as a lithium-containing layer. In some embodiments, the release layer 120 includes one or more nanosheets, such as one or more two-dimensional (2D) materials. In some embodiments, the release layer has a thickness of about 1 nm to about 500 nm, such as about 10 nm to about 300 nm, such as about 50 to about 200 nm. In some embodiments, the release layer 120 includes a plurality of sub-layers, each layer having a thickness of about 5 nm or less.

As used herein, a “2D material,” is an atomically thin crystalline solid having a single or few layered structure. In some embodiments, the 2D materials herein have intralayer covalent bonding and interlayer van der Waals bonding. In some embodiments, the 2D material can have a property selected from the group consisting of high carrier mobility, superconductivity, mechanical flexibility, high thermal conductivity, high optic and UV adsorption, a peel strength on silicone of about 3 to about 100 gram-force/in, weak interlayer bonding, and combinations thereof. The peel strength can be measured using TESA 7475 test tape having a width of 25 mm, and using a peeling angle of 180° and a peeling speed of 300 mm/min (3M method). Without being bound by theory, it is believed that selecting a 2D material having weak interlayer bonding enables ease of subsequently peeling the release layer from the support layer. In some embodiments, each of the layers of the SIDT stack 100 can have a melting temperature that is higher than a melting temperature of the alkali metal-containing layer.

In some embodiments, each layer can have melting points that are equal and/or decrease with each added layer such that the support layer 110 has the highest melting point, the release layer has a melting point lower than the support layer and the alkali metal-containing layer has the lowest melting point. In some embodiments, the two-dimensional material includes one or more of titanium disulfide (TiS₂), tungsten disulfide (WS₂), molybdenum disulfide (MoS₂), boron nitride (BN), aluminum hydroxide oxide (AlHO₂), MoO₃, graphene, carbon fluoride (CFₓ), carbon nitride, layered double hydroxide, derivatives thereof, and combinations thereof. In some embodiments, the 2D material includes a metal nitride, a metal sulfide, a metal hydroxide oxide, a carbon-containing material, derivatives thereof, or combinations thereof.

In some embodiments, which can be combined with other embodiments, the support layer 110 can be or include, one or more layers selected from plastic, polymer materials, metallized plastic, metals, paper, multilayers thereof, or a combination thereof. Examples of suitable polymer materials include polyethylene terephthalate (PET), polyethylene naphthalate (PEN), polyimide (PI), poly(methyl methacrylate) (PMMA), cellulose tri-acetate (TAC), polypropylene (PP), polyethylene (PE), polycarbonates (PC), multilayers thereof, or a combination thereof. In some embodiments, which can be combined with other embodiments, the support layer 110 is a flexible support layer, for example, a web-based substrate.

FIG. 2 illustrates a schematic cross sectional view of a SIDT film stack 200. The SIDT film stack 200 includes a support layer 210, a release layer 220, a solid electrolyte-containing layer 240, and an alkali metal-containing layer 230, such as a lithium layer. The SIDT film stack 200 can be formed and transferred onto a substrate similar to the SIDT film stack 100 of FIG. 1. The solid electrolyte-containing layer 240 is between the release layer 220 and the alkali metal-containing layer 230. In some embodiments, the electrolyte is a metal salt, such as lithium salt. The lithium salt can be one or more of LiPF₆, LiAsF₆, LiCF₃SO₃, LIN (CF₃SO₃)₃, LiBF₆, Li-borohydride (0.7Li(CB₉H₁₀)-0.3Li(CB₁₁H₁₂)), LiClO₄BETTE electrolyte, or combinations thereof. The electrolyte can be in a gel or polymer matrix medium. Other additional layers are also contemplated to be disposed between the release layer 220 and the alkali metal-containing layer 230. In some embodiments, which can be combined with other embodiments, a dielectric layer 250 is optionally included in the SIDT film stack 200. The dielectric layer 250 can be lithium fluoride, aluminum oxide, aluminum hydroxide oxide, boron nitride, carbon nitride, titanium oxide, lithium titanium oxide, zirconium oxide, tantalum oxide, barium titanate, lithium zirconium oxide, molybdenum oxide, silicon oxide, lithium silicon oxide, or a combination thereof. In some embodiments, which can be combined with other embodiments, a metallic layer 260 is optionally included in the SIDT film stack 200. The metallic layer 260 can comprise silver, copper, aluminum, silicon, or a combination thereof. In some embodiments, which can be combined with other embodiments, a passivation layer 270 can optionally be included in the SIDT film stack 200. In some embodiments, the passivation layer 270 comprises a carbonate of the alkali metal in the alkali metal-containing layer 230. In some embodiments, which can be combined with other embodiments, the alkali metal-containing layer 230 is a lithium layer and the passivation layer 270 comprises lithium carbonate. The passivation layer 270 can be formed by exposure of the alkali metal-containing layer 230 to carbon dioxide. In some embodiments, the alkali metal-containing layer 230 is exposed to carbon dioxide in the presence of heat to form a carbonated alkali metal-containing passivation layer. Without wishing to be bound by theory, it is believed that the carbon dioxide reacts with the alkali metal to form a thin layer of alkali metal carbonate on the exposed surface of the alkali metal-containing layer 230. In some embodiments, the passivation layer 270, e.g., the lithium carbonate passivation layer, can have a thickness ranging from about 50 nm to about 100 nm. The passivation layer 270 can serve as a protective layer for the subjacent alkali metal-containing layer 230. For example, the passivation layer 270 can protect the subjacent alkali metal-containing layer 230 from oxidation and damage during storage and shipping.

The SIDT film stacks described herein are formed such that the alkali metal-containing layer, e.g., the lithium layer, is deposited last on the SIDT film stack. Depositing the lithium layer last enables forming the film stack without damaging the lithium layer, which typically has a lower melting point relative to other materials that are formed in energy storage devices. Conventional methods of forming energy storage devices include direct deposition of lithium on the anode. These methods further include maintaining the underlying substrate as the lithium layer is formed to prevent damage to the lithium. In contrast, the SIDT film stack and methods described herein, enable forming the alkali metal-containing layer 230, for example, a lithium layer, last prior to transferring the entire SIDT film stack to the substrate.

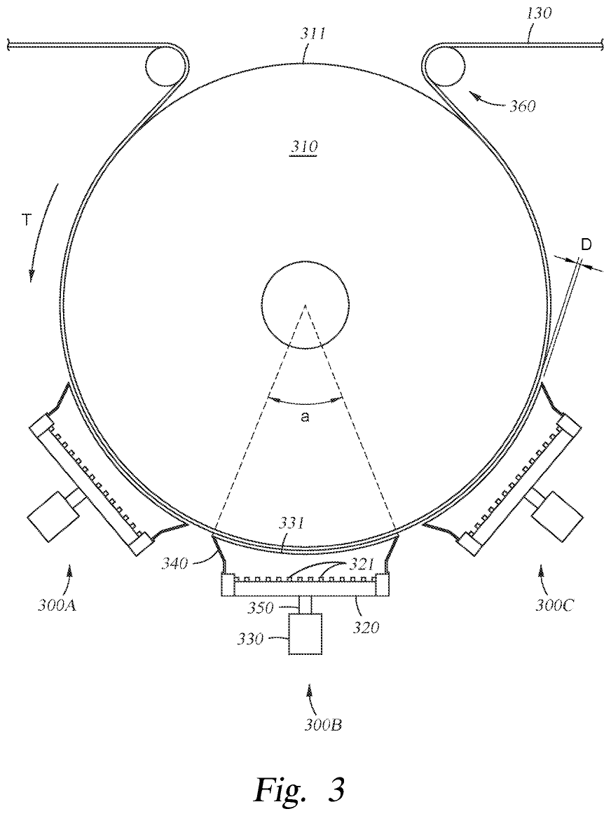

FIG. 3 illustrates a schematic view of a vapor deposition system viewed along a rotational axis of a drum 310. The drum 310 is rotatable about the rotational axis. The vapor deposition system is suitable for forming the SIDT film stack described herein, according to some embodiments. Vapor deposition systems for coating a web substrate being guided on a rotatable coating drum are referred to herein as roll-to-roll (R2R) deposition systems. Here, the web substrate is the support layer 110.

In some embodiments, the support layer 110 is continuously conveyed through the vapor deposition system by a combination of guidance wheels 360 and the drum 310 along with rollers on either end of the system that store the film stack (not shown). The support layer 110 is conveyed along the vapor deposition system against a curved substrate supporting surface of the drum 310. The support layer 110 is maintained tight against the drum 310 by the guidance wheels 360, so that the support layer 110 is flat against the drum 310 and so that there are substantially no creases or wrinkles on the support layer 110 as the flexible support layer is wrapped around the drum 310.

A vaporized 2D material can be deposited on the flexible support layer from a first vapor distribution assembly 300A as the substrate is conveyed against the surface of the drum 310. A plurality of nozzles 321 of the first vapor distribution assembly 300A are directed toward the curved drum surface 311, and the vapor deposition system is configured to move the support layer 110 on the curved drum surface 311 past first vapor distribution assembly 300A. The nozzles are spaced apart from the support layer 110 by a distance D. In some embodiments, the flexible support layer is conveyed continuously along the drum so that the vaporized 2D material is continuously deposited onto the support layer 110.

The material can be conveyed from an evaporation crucible 330 for evaporating the material to a vapor distributor 320. The vapor distributor 320 includes the plurality of nozzles 321 for directing the evaporated material in the evaporation crucible toward the support layer 110, such that a coating (e.g., release layer) is formed over the support layer 110. The evaporation crucible 330 is in fluid communication with the vapor distributor 320 via a conduit 350. In some embodiments, the conduit 350 is a linear connection tube or passage. In some embodiments, the vapor distributor 320 is a vapor distribution showerhead having the plurality of nozzles arranged in a 1-dimensional or 2-dimensional pattern for directing the evaporated material toward the support layer 110. During evaporation, the vapor distributor 320 is typically provided at a second temperature that is higher than a first temperature inside the evaporation crucible 330 in order to prevent a material condensation on inner wall surfaces of the vapor distributor.

In some embodiments, several vapor distribution assemblies 300A-300C as described herein may be arranged one after the other in the circumferential direction around the rotatable coating drum 310, such that the support layer 110 can be subsequently coated by several evaporation sources. Different coating materials can be deposited on the support layer 110, or one thicker coating layer of the same coating material can be deposited on the support layer 110 by the evaporation sources.

Each vapor distribution assembly 300A-300C can be arranged in any order to form one or more layers over the support layer 110 of the SIDT film stack. In some embodiments, the first vapor distribution assembly 300A is configured to deposit a release layer on the support layer 110. The second vapor distribution assembly 300B is configured to deposit a solid electrolyte-containing layer on the release layer. In some embodiments, the third vapor distribution assembly 300C is configured to deposit a lithium layer over the release layer or the electrolyte-containing layer. Each vapor distribution assembly may define a coating window on the curved drum surface 311 that extends over an angular range (a) of 10° or greater and 45° or less.

In some embodiments, which can be combined with other embodiments described herein, the vapor deposition apparatus further includes an edge exclusion shield 340 extending from at least one or more of the vapor deposition assemblies 300A-C, toward the curved drum surface 311. The edge exclusion shield may include an edge exclusion portion 331 for masking areas of the substrate not to be coated, e.g., for masking lateral edge areas of the support layer that are to be kept free of coating material. For example, the edge exclusion portion 331 may be configured to mask two opposing lateral edges of the support layer.

The edge exclusion portion 331 may extend along the curved drum surface 311 of the drum 310 in the circumferential direction T, following a curvature of the curved drum surface 311. Accordingly, the width D of a gap between the curved drum surface 311 and the edge exclusion portion 331 can be kept small (e.g., 2 mm or less) and essentially constant along the circumferential direction T, such that the edge exclusion accuracy can be improved and sharp and well-defined coating layer edges can be deposited on the substrate.

The “circumferential direction T” as used herein may be understood as the direction along the circumference of the drum 310 that corresponds to the movement direction of the curved drum surface 311 when the rotatable drum rotates around an axis. The circumferential direction T corresponds to the substrate transport direction when the substrate is moved past the evaporation source on the curved drum surface 311. In some embodiments, the drum 310 may have a diameter in a range of about 300 mm to about 1400 mm or larger.

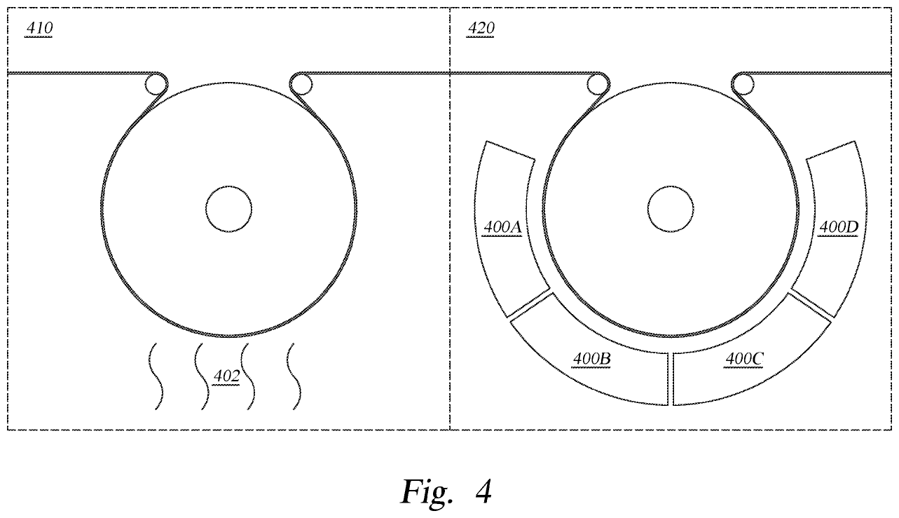

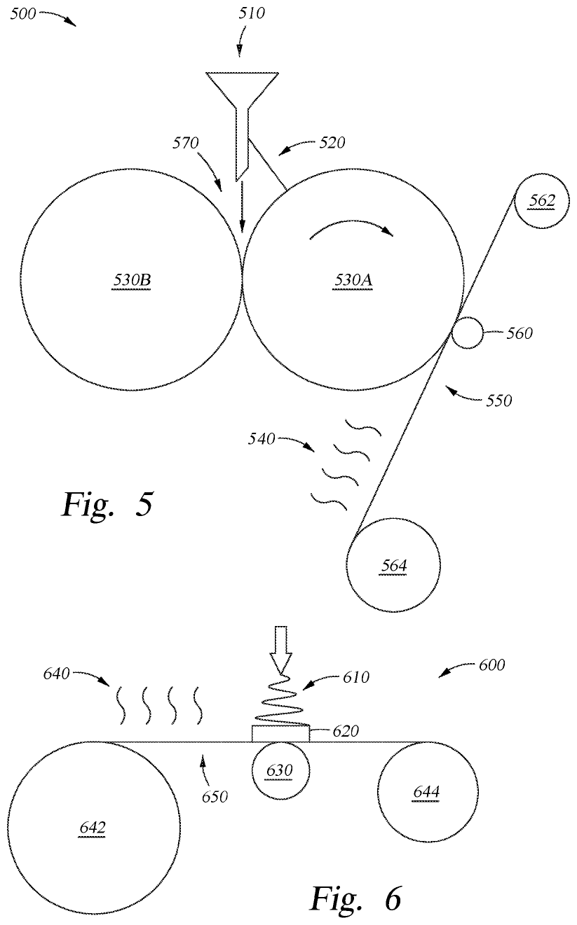

In some embodiments, the entire SIDT film stack is formed in a single process chamber. Alternatively, one or more layers of the SIDT film stack is deposited in a first process chamber 410 and one or more layers of the SIDT film stack are deposited in one or more additional process chambers, such as second process chamber 420. The first process chamber 410 and/or the second process chamber 420 can be each be vapor deposition systems such as the vapor deposition system described relative to FIG. 3. In some embodiments, such as the system depicted in FIG. 4, the first process chamber 410 includes a single evaporation source 402 and the second process chamber 420 includes one or more vapor distribution assemblies 400A, 400B, 400C, and 400D. The evaporation source 402 and the one or more vapor distribution assemblies 400A-400D may be any of the vapor deposition assemblies 300A-300C as shown in FIG. 3. In some embodiments, the first process chamber includes a mechanical system for transferring the release layer. Example mechanical systems useful for transferring the release layer is depicted and described relative to FIG. 5 and FIG. 6.

FIG. 5 depicts a mechanical transfer system 500 for transferring a release layer to the support layer. The mechanical transfer system 500 includes a feed assembly 510, such as a funnel shaped feed assembly configured to receive a granular material 570 and transfer the granular material 570 to an exterior surface of a first roller 530A. The first roller 530A can be actuated with a second rotating roller 530B. In some embodiments, a surface of the first roller 530A includes an adhesive for retaining the granular material 570 onto the surface of the first roller 530A prior to transferring the granular material 570. In some embodiments a blade 520 is coupled to the feed assembly 510 and configured to contact a top layer of the granular material 570 on the first roller 530A to a uniform thickness.

The support layer 550 from roll 564 is continuously fed between two rollers, the first roller 530A and a pivot roller 560 to roll 562. Prior to transferring the support layer 550 through the first roller 530A and the pivot roller 560, the support layer 550 is exposed to a plasma or a corona treatment 540 which sterilizes the support layer 550. The support layer 550 is then continuously fed through the first roller 530A and the pivot roller 560. The granular material 570 is adhered on the surface of the first roller 530A and pressed against the support layer 550 as the support layer 550 moves through the first roller 530A and the pivot roller 560. The granular material 570 transfers from the first roller 530A onto the support layer 550 to form a release layer onto the support layer 550. The support layer 550 with release layer can be transferred or continuously conveyed to a vapor deposition chamber where the other layers can be deposited on the support layer 550 and/or release layer. Other mechanical methods of transferring two-dimensional materials are also contemplated.

FIG. 6 illustrates an alternative mechanical transfer system 600 for mechanically transferring a release layer on a support layer 650. The support layer 650 is fed from a roll 642 to a roll 644. Between roll 642 and 644, the support layer 650 is conveyed between a block of solid 2D material 620 and a roller 630. In some embodiments, the support layer 650 is exposed to a plasma or corona treatment 640 that sterilizes the support layer 650 prior to transferring the 2D material thereon. The block of solid 2D material 620 is retained against the support layer 650 by an application of force that is perpendicular to a surface of the support layer 650. In some embodiments, the force is provided by a spring 610 such that a constant force is held against the block of the 2D material 620 toward the support layer 650. As the block of solid 2D material 620 is held against the support layer 650, layers of the 2D material are transferred from the block of the 2D material 620 to the support layer 650 to form a release layer over the support layer. The support layer 650 with the release layer can be transferred or conveyed to a vapor deposition chamber where the other layers can be deposited thereon.

Once the SIDT film stack is fully formed, portions or layers of the SIDT film stack can be transferred to a substrate to form the energy storage device. In some embodiments, the SIDT film stack can include a polyethylene terephthalate (PET) layer, a release layer, a dielectric layer, a metallic layer, a lithium or lithium alloy layer, and a surface passivation layer. The dielectric layer can include lithium fluoride, aluminum oxide, aluminum hydroxy oxide, boron nitride, carbon nitride, titanium oxide, lithium titanium oxide, zirconium oxide, tantalum oxide, barium titanate, lithium zirconium oxide, molybdenum oxide, silicon oxide, lithium silicon oxide, and combinations thereof. The metallic layer can include silver, copper, aluminum, silicon, or combinations thereof. In some embodiments, the SIDT film stack is laminated and calendared before transferring.

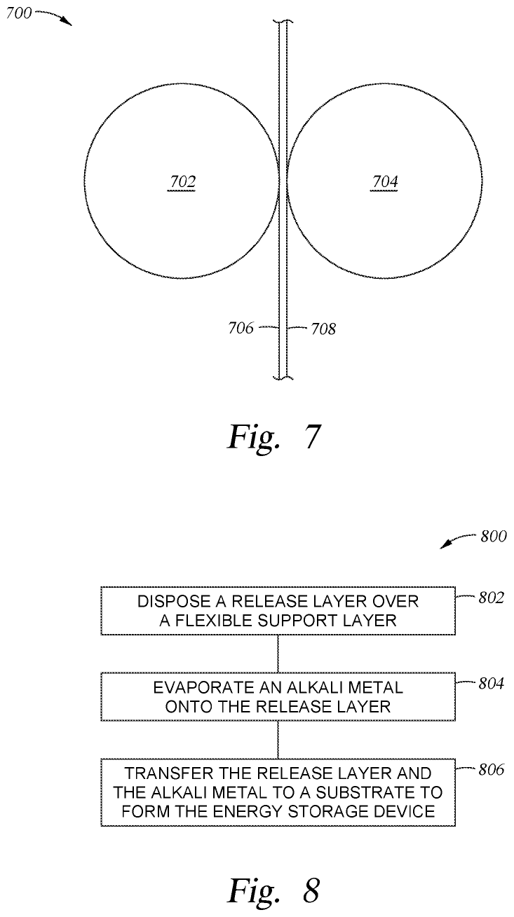

A system 700 for transferring layers from the SIDT film stack 706 to a substrate 708 is depicted in FIG. 7. The SIDT film stack 706 and substrate 708 can be conveyed together between two rollers 702, 704. In some embodiments, the support layer of the SIDT film stack interfaces the surface of roller 702 and a lithium layer of the SIDT film stack interfaces the substrate 708. The rollers 702, 704, such as stainless steel rollers, can be heated and pressed together to a temperature that enables transferring of the release layer, lithium layer and other layers from the support layer to the substrate.

FIG. 8 depicts a process flow diagram of a method 800 for forming an energy storage device. The method 800 includes disposing a release layer over a flexible support layer, in operation 802. One or more of the systems described herein can be used to deposit or mechanically transfer the release layer over the support layer. The release layer includes one or more nanosheets. The one or more nanosheets includes a two-dimensional material. In some embodiments, the one or more nanosheets are deposited by chemical vapor deposition, atomic layer deposition, molecular layer deposition, physical vapor deposition, or combinations thereof. In some embodiments, the 2D material is transferred to the flexible support layer by coating a roller with a 2D material in a granular form and pressing the roller against the flexible support layer to transfer the powder from the roller to the flexible support layer while the flexible support layer is conveyed on a surface of one or more rollers.

Additional layers can be included on the release layer such as evaporating an alkali metal onto the release layer, in operation 804. In some embodiments, an ion conducting electrolyte containing layer is formed on the release layer prior to transferring the alkali metal onto the release layer. The alkali metal can be a lithium that is useful for use in energy storage devices. In some embodiments a metal, such as lithium, is evaporated in an evaporation crucible, such as any of the evaporation crucibles described herein. The evaporation crucible is heated to a temperature of about 500° C. or greater, such as about 600° C. to about 1200° C., such as about 700° C. to about 1000° C.

In operation 806, the release layer and the alkali metal layer is transferred to a substrate to form the energy storage device, such as by using the system 700 described in FIG. 7. The substrate may be a flexible substrate, such as a CPP film (i.e., a casting polypropylene film), an OPP film (i.e., an oriented polypropylene film), or a PET film (i.e., an polyethylene terephthalate film). Alternatively, the flexible substrate may be a pre-coated paper, a polypropylene (PP) film, a PEN film, a polylactic acid (PLA) film, or a PVC film. The substrate can further include one or more current collectors, the current collector can include aluminum (Al), copper (Cu), zinc (Zn), nickel (Ni), cobalt (Co), manganese (Mn), chromium (Cr), stainless steel, clad materials, alloys thereof, and a combination thereof.

In some embodiments, at least one of the current collectors is perforated. In one embodiment, at least one of the current collectors includes a polymer substrate (e.g., polyethylene terephthalate (“PET”) coated with a metallic material. In one embodiment, the anode current collector is a polymer substrate (e.g., a PET film) coated with copper. In another embodiment, the anode current collector is a multi-metal layer on a polymer substrate. The multi-metal layer can be combinations of copper, chromium, nickel, alloys thereof, or any combination thereof. In one embodiment, the anode current collector is a multi-layer structure that includes a copper-nickel cladding material. In one embodiment, the multi-layer structure includes a first layer of nickel or chromium, a second layer of copper formed on the first layer, and a third layer including nickel, chromium, or both formed on the second layer. In one embodiment, the anode current collector is nickel coated copper. In one embodiment, the anode current collector is graphite coated copper. Furthermore, current collectors may be of any form factor (e.g., metallic foil, sheet, or plate), shape and micro/macro structure.

In some embodiments, the anode has a thickness from about 10 μm to about 200 μm (e.g., from about 1 μm to about 100 μm; from about 10 μm to about 30 μm; from about 20 μm to about 30 μm; from about 1 μm to about 20 μm; or from about 50 μm to about 100 μm).

The previously described embodiments of the present disclosure have many advantages, including the following. The methods and SIDT film stack described herein enable forming a lithium containing film stack that can be transferred to an anode for use in an energy storage device. Upon transferring the layers of the SIDT film stack, a release layer is transferred with a lithium layer and provides protection to the lithium layer. However, the present disclosure does not require that all the advantageous features and all the advantages need to be incorporated into every embodiment of the present disclosure.

In the Summary and in the Detailed Description, and the Claims, and in the accompanying drawings, reference is made to particular features (including method operations) of the present disclosure. It is to be understood that the disclosure in this specification includes all possible combinations of such particular features. For example, where a particular feature is disclosed in the context of a particular aspect, embodiment, embodiment, or example of the present disclosure, or a particular claim, that feature can also be used, to the extent possible in combination with and/or in the context of other particular aspects and embodiments of the present disclosure, and in the present disclosure generally.

The term “comprises” and grammatical equivalents thereof are used herein to mean that other components, ingredients, operations, etc. are optionally present. For example, an article “comprising” (or “which comprises”) components A, B, and C can consist of (i.e., contain only) components A, B, and C, or can contain not only components A, B, and C but also one or more other components. In addition, whenever a composition, an element or a group of elements is preceded with the transitional phrase “comprising” or grammatical equivalents thereof, it is understood that it is contemplated that the same composition or group of elements may be preceded with transitional phrases “consisting essentially of,” “consisting of,” “selected from the group of consisting of,” or “is” preceding the recitation of the composition, element, or elements and vice versa.

Where reference is made herein to a method comprising two or more defined operations, the defined operations can be carried out in any order or simultaneously (except where the context excludes that possibility), and the method can include one or more other operations which are carried out before any of the defined operations, between two of the defined operations, or after all of the defined operations (except where the context excludes that possibility).

While the foregoing is directed to embodiments, other and further embodiments may be devised without departing from the basic scope, and the scope is determined by the claims that follow.

What is claimed is:

1. An alkali metal-containing film stack for energy storage devices, comprising:
a flexible support layer;
a release layer disposed over the flexible support layer capable of separating from the flexible support layer, the release layer comprising one or more nanosheets; and
an alkali metal-containing layer disposed over the release layer.

2. The film stack of claim 1, further comprising an electrolyte-containing layer disposed between the release layer and the alkali metal-containing layer.

3. The film stack of claim 1, wherein the alkali metal-containing layer comprises lithium.

4. The film stack of claim 1, wherein the film stack comprises one or more additional film layers disposed between the flexible support layer and the alkali metal-containing layer, each of the one or more additional film layers having a melting point higher than a melting point of the alkali metal-containing layer.

5. The film stack of claim 1, wherein the flexible support layer comprises a material selected from the group consisting of polyethylene terephthalate (PET), paper, and a combination thereof.

6. The film stack of claim 1, wherein the one or more nanosheets comprises a two-dimensional material is selected from the group consisting of titanium disulfide (TiS₂), tungsten disulfide (WS₂), molybdenum disulfide (MoS₂), boron nitride (BN), aluminum hydroxide oxide (AlHO₂), MoO₃, graphene, carbon nitride, layered double hydroxide, derivatives thereof, and combinations thereof.

7. The film stack of claim 1, wherein the alkali metal-containing layer is capable of adhering to an anode.

8. The film stack of claim 1, wherein the release layer has a thickness of about 1 nm to about 500 nm.

9. An energy storage device comprising an anode and the film stack of claim 1 disposed over the anode.

10. A method of making an energy storage device, comprising:
disposing a release layer over a flexible support layer, the release layer comprising one or more nanosheets;
evaporating an alkali metal onto the release layer; and
transferring the release layer and the alkali metal to a substrate to form the energy storage device.

11. The method of claim 10, wherein the one or more nanosheets comprise a two-dimensional material, wherein the two-dimensional material is transferred to the flexible support layer by coating a roller with a powder comprising the two-dimensional material and pressing the roller against the flexible support layer to transfer the powder from the roller to the flexible support layer while the flexible support layer is conveyed on a surface of one or more rollers.

12. The method of claim 10, wherein the one or more nanosheets comprise a two-dimensional material, wherein the two-dimensional material is transferred to the flexible support layer by pressing a solid comprising the two-dimensional material against the flexible support layer as the flexible layer is conveyed on a surface of one or more rollers.

13. The method of claim 12, wherein pressing the solid comprises applying spring tension against the solid in a direction perpendicular to the surface of the flexible support layer.

14. The method claim 10, wherein the one or more nanosheets are deposited by chemical vapor deposition, atomic layer deposition, molecular layer deposition, physical vapor deposition, or combinations thereof.

15. The method of claim 10, further comprising depositing an electrolyte containing layer over the release layer.

16. A method of making an energy storage device, comprising:
disposing a release layer over a flexible support layer, the release layer comprising a two-dimensional material;
evaporating lithium onto the release layer to form a lithium layer; and
transferring the release layer and the lithium layer to a substrate to form the energy storage device.

17. The method of claim 16, wherein the release layer and the lithium layer are deposited in the same process chamber.

18. The method of claim 16, wherein the release layer is transferred onto the flexible support layer in a first chamber and the lithium layer is deposited onto the release layer in a second chamber.

19. The method of claim 18, further comprising depositing an electrolyte-containing layer over the release layer, wherein the electrolyte-containing layer is deposited in the first chamber or the second chamber.

20. The method of claim 16, wherein the release layer is transferred onto the flexible support layer in a first chamber and the lithium layer is deposited onto the release layer in the first chamber.
